(19) United States
(12) Patent Application Publication
(10) Pub. No.: US 2011/0297493 A1
(43) Pub. Date: Dec. 8, 2011

(54) BRAKE BOOSTER

(76) Inventors: Herbert Vollert, Vaihingen/Enz (DE); Stephan Hoenle, Korntal-Muenchingen (DE)

(21) Appl. No.: 13/140,941

(22) PCT Filed: Nov. 30, 2009
(86) PCT No.: PCT/EP2009/066031

§ 371 Date: Jul. 12, 2011

(30) Foreign Application Priority Data
Dec. 18, 2008 (DE) 102008054862.6
Nov. 30, 2009 (DE) 102009047263.0

(51) Int. Cl. B60T 13/66; B60T 13/58

(52) U.S. Cl. 188/106 R

(57) ABSTRACT

The invention relates to an electromechanical brake booster having a piston rod to be actuated using muscular power, and an electromechanical actuator. Muscular power acting upon the pedal rod is transmitted via an elastic transmission element, for example a spring element, and the actuator power is transmitted separately thereof via its proper elastic transmission element which has for example a number of spring elements and dampers arranged in parallel thereto. The controllable brake booster is operated depending on a variable representing the relative deviation of the booster body and the input element. The brake booster according to the invention allows the adjustment of a booster characteristic which is variable in a wide range and which inter alia can depend on an actuation path, an actuation speed and/or an actuation acceleration. The switch-over to different modes, for example a sports mode, is also possible.

### PRIOR ART

The invention relates to a brake booster, having the characteristics of the preamble to claim 1, which is intended in particular for motor vehicles. Within the scope of this invention, the term “control” also includes regulation.

Underpressure brake boosters are conventional in passenger cars today; they have an underpressure chamber with a diaphragm in their interior, which divides the underpressure chamber into two compartments. In both compartments, underpressure prevails, that is, pressure that is lower than the ambient pressure. Upon brake actuation, one of the two compartments is subjected to ambient air (not necessarily at ambient pressure, but at ambient pressure only with maximum force boosting), as a result of which a force is exerted on the diaphragm that is exerted as external force in addition to muscle power on a piston of a hydraulic master cylinder. The underpressure chamber having the diaphragm can be conceived of as an actuator, namely as a pneumatic or underpressure actuator of the brake booster.

Electromechanical brake boosters are also known, which have the advantage that they do not require any underpressure. For that reason, they can be used without an underpressure pump in motor vehicles with diesel engines, which for structural reasons do not have (sufficient) underpressure in the intake system for operating an underpressure brake booster. In modern Otto engines with direct gasoline injection or lean mixture engines as well, the underpressure in the intake system is sometimes inadequate for operating an underpressure brake booster. Other areas in which electromechanical brake boosters can be used are hybrid vehicles with combined drive by means of one or more electric motors and an internal combustion engine, or electric vehicles.

German Published Patent Application DL 100 57 557 A1 discloses an electromechanical brake booster with an electromechanical actuator, whose actuator force is exerted as external force, in addition to muscle power exerted by a vehicle driver, on a piston of a master cylinder. The known electromechanical brake booster has an electromagnet or a linear motor as its electromechanical actuator. For instance, an electric motor with a downstream rotation/translation conversion gear is conceivable, in which a step-down gear can be disposed between the electric motor and the conversion gear. This list is not exhaustive.

A common feature of brake boosters is that they have an input element, which can be actuated upon by the vehicle driver with muscle power, the actuator already mentioned, and an output element that subjects the piston of a master cylinder to an actuation force. It is conceivable for the piston of the master cylinder already to form the output element, but normally these are two different components. The input element of known brake boosters is typically a piston rod, which is connected in articulated fashion with a (foot) brake pedal. A manual brake lever can also form the input element or be connected in articulated fashion to the piston rod of the brake booster. The brake booster adds up an actuator force, generated by the actuator, and the muscle power, exerted on the input element by the vehicle driver, and transmits the two forces as the actuation force to the output element. The ratio of the actuator force to the muscle power can be constant, or variable. Normally, adding together the actuator force and the muscle power to make the actuation force is done mechanically in the brake booster.

The output element of known brake boosters is typically a so-called push rod.

For transmitting and adding up the actuator force and the muscle power, the known electromechanical brake booster has a so-called reaction disk. This is a rubber-elastic disk that is acted upon by the actuator and by the input element and which in turn acts on the output element. The reaction disk damps the infeed of the actuator force and makes relative motions possible between the muscle-power-actuated input element and the actuator.

### DISCLOSURE OF THE INVENTION

The controllable brake booster according to the invention having the characteristics of claim 1 has a deformable transmission element, which transmits the muscle power, exerted by the vehicle driver on the input element, to the output element. Unlike the reaction disk of the known electromechanical brake booster, the transmission element of the brake booster of the invention is not acted upon by the actuator; the actuator force is fed in a different way. According to the invention, the brake booster has a booster body and is operated as a function of a variable representing a relative deflection of the booster body and of the input element.

In this context, controllable is understood to mean controllable and/or regulatable, and no distinction will be made between these terms hereinafter.

Preferably, the actuator, too, has a deformable transmission element for transmitting the actuator force to the output element. This is the subject of claim 13.

Preferably, the transmission element is elastically deformable, or in other words is for instance a rubber-elastic element, or a spring element, such as a helical compression spring. The transmission element can have a spring constant or a nonlinear characteristic spring curve. It is not necessary for the transmission element to be disk-shaped. The transmission element can also have an incompressible fluid, which is enclosed for instance within a constant volume, for instance in a bellows or a bag. In general, the transmission element can be conceived as an element which transmits the actuator force of the actuator and the muscle power of the input element to the output element as a function of a change in shape and/or a speed of a change in shape. The transmission element can act in damping fashion, for instance damping vibration and/or shock. The force transmission properties of the transmission element or transmission elements can be variable, for instance also controllable. It is conceivable for the transmission element to have a non-Newtonian fluid. For instance, a change in the force transmission properties of the transmission element is possible with a magneto-rheological or electro-rheological fluid, whose viscosity can be varied by means of a magnetic or an electrical field. The above remarks apply to both the transmission element of the input element and, if present, to the transmission element of the actuator.

An advantage of the invention is that the feeding in of the actuator force and the muscle power independently of one another makes the feeding in considerably more variable than in known brake boosters. The ratio of the actuator force to the muscle, that is, the boosting ratio, is controllable or regulatable over a wide range; a comparatively great relative motion of the input element with respect to the actuator is possible, as are different speeds and accelerations of the input element and of the actuator. The pedal feel and brake feel can be adjusted or changed over wide ranges and adapted for instance to external factors such as the vehicle speed, the nature of the road, or a desire of a vehicle driver, such as a sport mode. Pedal feel, which the vehicle driver feels at the brake pedal (or a hand brake lever), means how strong the muscle power is, at which position of the brake pedal, and as a function of the pedal speed. The brake feel is the delay, felt by the vehicle driver, during a braking event. A jump-in function is also possible, in which in a low force range (brake pressure less than 15 bar, for instance), the control or regulation of the actuator force, controlled in terms of travel by the travel of the input element, is effected at a virtually constant muscle power. The actuation force can be exerted in this range entirely by the actuator. The operation of the brake booster as a function of the relative deflection of the booster body and of the input element has the advantage that it is possible to operate the brake booster with only travel sensors, and thus force sensors can be dispensed with, which lowers the costs.

The dependent claims have advantageous features and refinements of the invention defined by claim 1 as their subjects.

For implementing the jump-in function explained above, claim 2 provides an idle travel of the input element before it acts on the output element via the transmission element. This is attained by operating the brake booster in a first mode of operation, in which the relative deflection between the booster body and the input element is adjusted such that the idle travel is not overcome. In a second mode of operation, it is provided that the idle travel is overcome, by adjustment of the relative deflection. The division into a first and second mode of operation is not necessarily to be understood as a consequence; the brake booster can advantageously also be operated in only the first or only the second mode of operation.

Until the idle travel is overcome, the input element can move without force or normally counter to the force of a restoring spring of a brake pedal, or in other words with negligibly little muscle power. In accordance with the characteristics of claim 3, in the first mode of operation the brake force is exerted solely by the actuator. In the second mode of operation, conversely, the brake force is exerted by the actuator force and/or by the muscle power. The term brake force is intended to mean the wheel brake force of the vehicle wheels.

In the first mode of operation, the brake booster of the invention can be operated in such a way that there is a fixed relative deflection between the input element and the booster body. In particular, it can be provided that the relative deflection is set to zero. Operating the brake booster in this way ensures that the idle travel will not be overcome.

Advantageously, in the second mode of operation it can be provided that the brake booster is adjusted on the basis of a predetermined relationship between a displacement travel of the booster body and the relative deflection. Thus a characteristic for the brake booster can be specified on the basis of this predeterminable relationship.

Advantageously, a transition from the first mode of operation to the second mode of operation of the brake booster, or vice versa, can be dependent on the existing pressure in the brake system, on the displacement travel of the booster body, and/or on the displacement travel of the input element. It is understood that by way of this dependency, the transition between the first mode of operation and the second mode of operation can then be adjusted as well. In this way, the brake booster can be operated for instance at low pressure in the brake system in the first mode of operation and at a higher pressure in the brake system in the second mode of operation.

Advantageously, in accordance with dependent claims 7 and 8, the aforementioned relationship between the displacement travel of the booster body and the relative deflection to be adjusted can be stored in memory in the vehicle in the form of a characteristic curve, for instance in a control unit of the brake booster. This characteristic curve can for instance be selected by the driver, or it can be adapted automatically to ambient conditions or driving situations. For instance, in traveling on the Autobahn, a different characteristic curve can be provided than for driving in a city or in driving downhill in the mountains.

According to claims 9 and 10, the muscle power to be exerted given an existing displacement travel can be adjusted by adjusting the relative deflection. The ratio of the actuator force to the muscle power can also be adjusted by adjusting the relative deflection.

It can furthermore be provided that the boosting ratio, that is, a ratio of actuator force to muscle power, and/or the relationship between the displacement travel and the relative deflection to be adjusted, is adjusted as a function of a speed and/or an acceleration of the booster body and/or of the input element. The terms “speed” and “acceleration” mean for instance an actuation speed and an actuation acceleration, respectively. This makes it possible to provide a different characteristic curve, for instance upon very fast actuation of the brake pedal in an emergency situation, in order to make an increased, and in particular the maximum, brake force available for the braking event.

To determine the variables necessary for operating the brake booster, such as the displacement travel, the relative deflection, the speed, and/or the acceleration, it is provided that signals from suitable sensors be used. The sensors can make these signals available either directly or indirectly. It is also possible for these signals to be further processed by computer, for instance, in further ascertainment steps.

Implementing the jump-in function is also possible if the transmission element of the input element has no prestressing (claim 16). The invention is not limited to underpressure brake boosters and electromechanical brake boosters but instead extends to brake boosters in general, regardless of what type they are. In particular, however, it is intended for an electromechanical brake booster, that is, a brake booster that has an electromechanical actuator.

The jump-in function already mentioned earlier herein can be described by the aforementioned claims. The first mode of operation can be identified with the jump-in function. At a low brake force of a vehicle brake system, the actuation force exerted on a master cylinder, for instance, is exerted entirely by the actuator of the brake booster. Specifically, this is external force braking, solely by the actuator force, which is an external force, without muscle power on the part of a vehicle driver. The term brake force means the wheel brake force of the vehicle wheels. For characterizing a low brake force, in a hydraulic vehicle brake system the wheel brake pressure in wheel brake cylinders can be used. At a low brake force, the wheel brake force is for instance no greater than approximately 15 bar. The control of the brake booster is effected in particular in travel controlled fashion as a function of a pedal travel, and the low brake force can also be characterized by a short pedal travel in proportion to a maximum pedal travel. Operating conventional brake boosters in accordance with the invention is not precluded. Conventional brake boosters are for instance underpressure brake boosters or electromechanical brake boosters with an elastic reaction disk as a deformable transmission element, which transmits both the muscle power exerted by a vehicle driver on the input element of the brake booster and the actuator force of the actuator to the output element of the brake booster. Operating the brake booster in accordance with the invention is advantageous because of the mutually independent feeding in of the actuator force and the muscle power. The increase in the actuator force does not necessarily lead to feedback on the muscle power. In an electromechanical brake booster with a reaction disk, the disk is compressed by the actuator force and consequently deforms elastically in its middle back in the direction of the input element of the brake booster. Because of the deformation, the reaction disk exerts a force on the input element that is oriented counter to an actuation direction and that has to be compensated for by muscle power on the part of the vehicle driver. Brake actuation solely by the actuator force is therefore possible in only a limited way, if at all, in an electromechanical brake booster that has a reaction disk.

### BRIEF DESCRIPTION THE DRAWINGS

The invention will be described in further detail below in terms of two embodiments shown in the drawings. The two drawing figures show axial sections of two embodiments of brake boosters of the invention. The drawings are to be understood as a schematic, simplified illustration for the sake of comprehension and explanation of the invention.

### EMBODIMENTS OF THE INVENTION

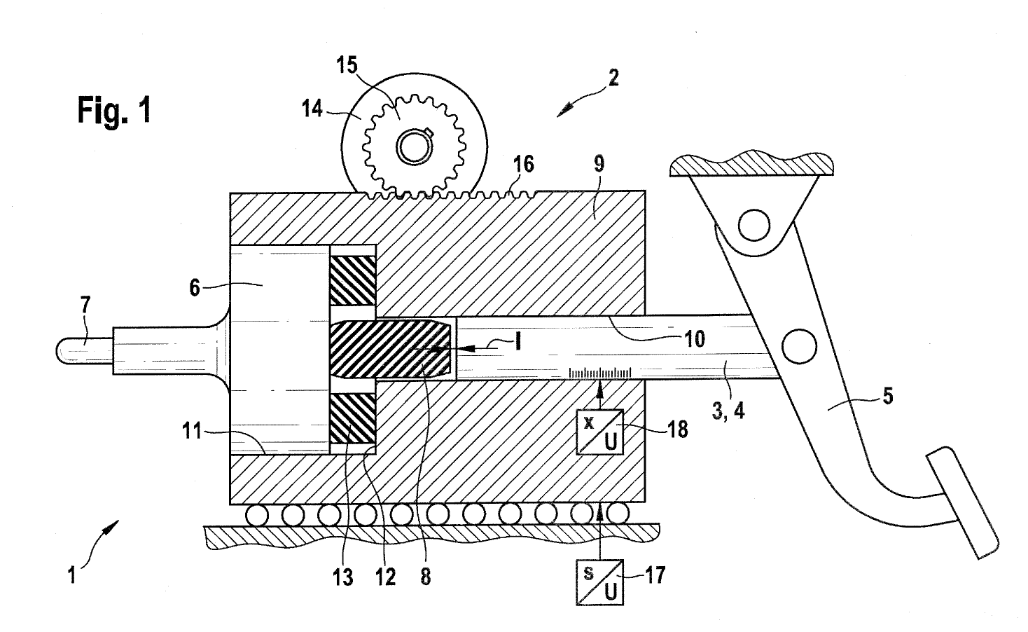

The brake booster 1 according to the invention, shown in FIG. 1, is an electromechanical brake booster 1, having an electromagnetic actuator 2, to be explained hereinafter, and a piston rod 3 that can also be conceived of in general as an input element 4 that is actuatable by muscle power. The piston rod 3 is connected in articulated fashion to a brake pedal 5. The brake booster 1 furthermore has an output element 6, with a piston-shaped base and a push rod 7, with which, in a manner known per se, a primary or rod piston, not shown, of a hydraulic master cylinder, also not shown, of a hydraulic vehicle brake system can be subjected to an actuation force.

Between the output element 6 and the piston rod 3 is a rubber-elastic boltlike transmission element 8. Via the transmission element 8, a muscle power, which is exerted on the piston rod 3 by the brake pedal 5, can be transmitted to the output element 6 of the brake booster 1. The transmission element 8, which has elastic and damping properties, can comprise rubber or a rubber-elastic plastic.

The actuator 2 has a booster body 9, which in the embodiment shown is cylindrical and has an axial through hole 10, in which the piston rod 3 is axially displaceably received. The transmission element 8 of the piston rod 3 is also received axially displaceably in the through hole 10 of the booster body 9, and the through hole 10 of the booster body 9 additionally acts like a kind of setting or sheathing of the transmission element 8 and limits its radial length upon the exertion of axial force.

The transmission element 8 is somewhat shorter than the spacing between the piston rod 3 and the output element 6, when the brake booster 1 is in the basic, unactuated, position shown. As a result, the piston rod 3 and the brake pedal 5 have an idle travel 1, by which they can be moved before the piston rod 3, via the transmission element 8, transmits the muscle power to the output element 6 of the brake booster 1.

The through hole 10 of the booster body 9 opens into a cylindrical countersunk feature 11, which has a greater diameter than the through hole 10 and in which the output element 6 is axially displaceably received. Between the output element 6 and a base 12 of the countersunk feature 11 is a rubber-elastic transmission element 13, which in the embodiment of the invention shown is annular and concentrically surrounds the transmission element 8 of the piston rod 3. The annular transmission element 13 of the actuator 2 transmits an actuator force from the booster body 9 to the output element 6. The annular transmission element 13 likewise has elastic and damping properties and can comprise rubber or a rubber-elastic plastic.

Like the piston rod 3 and the output element 6, the booster body 9 is axially displaceable, which is represented symbolically in the drawing by a roller bearing on the underside of the booster body 9.

As its drive, the actuator 2 has an electric motor 14, with which, via a toothed edge 15, the booster body 9 is drivable in the axial direction. The gear wheel 15 meshes with a rack 16 of the booster body 9. A step-down gear, not shown, can be disposed between the gear wheel 15 and the electric motor 14. Instead of an electric motor drive, the electromagnetic actuator 2 can for instance have an electromagnetic drive or a linear motor (not shown). An electromagnetic actuator 2 is preferred but not mandatory; a pneumatic underpressure, pressure, or overpressure actuator, or a hydraulic actuator, is also conceivable. This list is not exhaustive.

The electromechanical brake booster 1 has a travel sensor 17, with which a displacement and thus also a speed and an acceleration of the booster body 9 can be measured, and a position sensor 18, with which a relative motion, that is, a displacement of the piston rod 3 relative to the booster body 9, can be measured.

An elastic transmission element 13 between the booster body 9 and the output element 6 for transmitting the actuator force is not compulsory; the output element 6 can also be coupled rigidly to the actuator 2, for instance by means of a direct contact of the output element 6 with the base 12 of the countersunk feature 11 of the booster body 9, or by the interposition of a rigid ring, for instance of steel, between the output element 6 and the base 12 of the countersunk feature 11 (not shown). The booster body 9, the electric motor 14, and the gear wheel 15 meshing with the rack 16 of the booster body 9 form the electromagnetic actuator 2 of the brake booster 1.

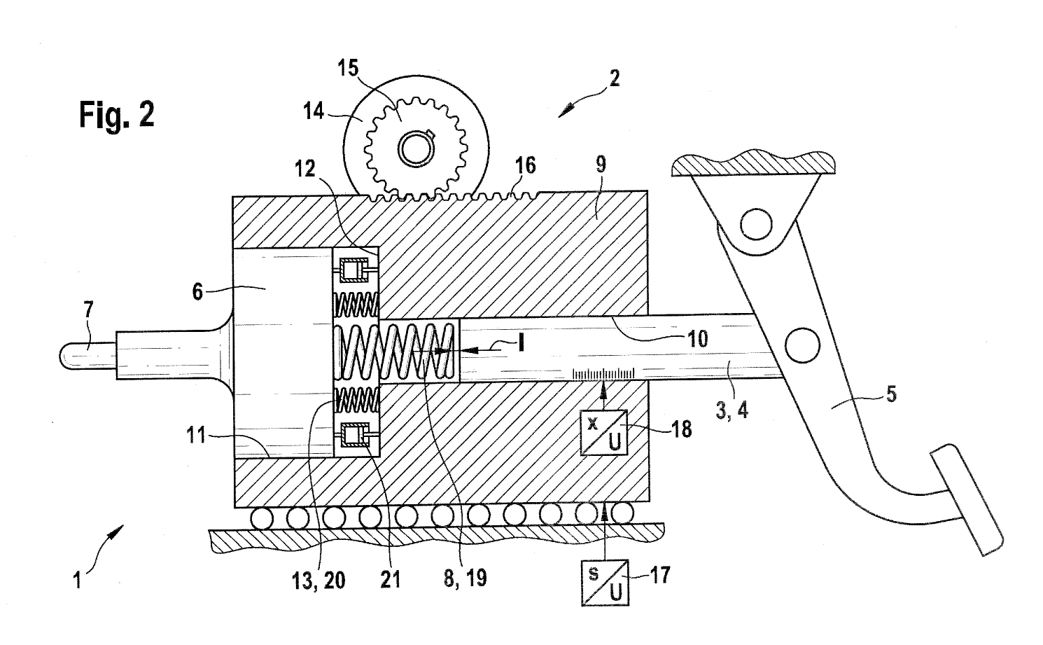

In the brake booster 1 of the invention shown in FIG. 2, in comparison to FIG. 1, the two transmission elements 8, 13 are replaced; specifically, the transmission element 8 of the pedal rod 3 is replaced by a spring element 19, and the annular transmission element 13 of the actuator 2 is replaced by a number of spring elements 20, which are disposed around an imaginary concentric circle around the spring element 19 of the pedal rod 3. Dampers 21, which are disposed acting mechanically parallel, are assigned to the spring elements 20 of the actuator 2. In the embodiment shown, the spring elements 19, 20 are helical compression springs. The spring element 19 of the piston rod 3 forms its elastic transmission element 8; the spring elements 20 and the damper 21 of the actuator 2 form its resilient and damping transmission element 13. Otherwise, the brake booster 1 of FIG. 2 is embodied like that of FIG. 1 and functions in the same way. In the two drawings, identical parts have the same reference numerals. To avoid repetition, for explaining FIG. 2 reference is made to the description of FIG. 1.

For a brake actuation, the brake pedal 5 is depressed as usual, in order thereby to transmit muscle power, via the piston rod 3 and its rubber-elastic transmission element 8, to the output element 6, which with its push rod 7 acts on the piston, not shown, of the master cylinder. An electronic regulator, not shown, supplies current to the electric motor 14 of the actuator 2 such that the booster body 9 moves in the direction of the output element 6 as well. Via its transmission element 13, it exerts an actuator force on the output element 6. The muscle power exerted by the piston rod 3 and the actuator force exerted by the booster body 9 are added up mechanically by the output element 6 and form the actuation force which, via the push rod 7, acts on the piston of the master cylinder. What is regulated is the relative motion of the piston rod 3 with respect to the booster body 9, or in other words a displacement of the piston rod 3 relative to the booster body 9, which is measured by the position sensor 18.

The relative motion can be regulated to “0”, or in other words such that the booster body 9 moves synchronously with the piston rod 3. The regulation of a lead or a lag of the booster body 9 relative to the piston rod 3 is also possible; that is, the booster body 9 is displaced farther or not as far as the piston rod 3.

By the operation of the brake booster on the basis of the displacement of the booster body 9 and the piston rod 3 and with the utilization of the idle travel 1, two modes of operation of the brake booster can be implemented.

In a first mode of operation, it can be provided that the brake booster be operated such that the idle travel 1 is not overcome. This is possible because in the regulation of the brake booster, a displacement of the booster body 9 with respect to the piston rod 3 is always set, so that the piston rod 3 does not come into contact with the elastic element 8, 19. For that purpose, a fixed displacement of the booster body 9 with respect to the piston rod 3, and in particular a displacement of zero, can be set.

In this mode of operation, the so-called jump-in function is implemented. Thus by means of the regulation, for instance at the onset of a brake actuation, or in other words at the beginning of the displacement of the piston rod 3, an actuation force can be generated essentially only by the actuator 2. The muscle power exerted on the brake pedal 5 is virtually constant and low. The actuator force is regulated as a function of the displacement of the piston rod 3. It is also possible to implement the jump-in function without the idle travel 1, if the transmission element 8 of the piston rod 3 that forms the input element 4 has no or at most only slight prestressing.

In a second mode of operation, it can be provided that the brake booster be operated such that the idle travel 1 is overcome. This is done by adjusting a displacement of the input element 3 to the booster body 9 such that the idle travel is overcome. In this second mode of operation, the actuation force is exerted both by the actuator 2 and by the driver via muscle power.

In the second mode of operation, the brake booster is operated on the basis of a predetermined relationship between the displacement x to be set and the position of the booster body s. This relationship can be stored in memory in the vehicle in the form of a characteristic curve.

In both modes of operation, the regulation can be done as a function of the displacement travel of the booster body 9, that is, as a function of its position, its speed, and/or its acceleration. Instead of the displacement of the booster body 9 of the actuator 2, it is also possible (not shown) to measure the displacement of the piston rod 3.

The boosting factor of the brake booster 1, that is, the ratio of the actuator force to the muscle power, can be adjusted freely within a wide range, and in particular also as a function of the displacement travel, that is, the position, the speed and/or the acceleration of the booster body 9 or of the pedal rod 3. Thus the boosting can be different upon fast pedal actuation from that with slow pedal actuation. The adjustment of the boosting factor is done by adjusting the applicable displacement x at a given position s of the booster body 9, or at the present position of the pedal rod 3. For instance, if a linear spring is assumed as the transmission element 8, 19, then it becomes clear that via the displacement x, the proportion of force exerted by the driver can be adjusted. The spring is braced on the master cylinder. The farther the brake booster allows the driver to compress the springs 8, 19 for example, the greater is the requisite power on the part of the driver. How far the driver compresses the spring can be fixed by adjusting the displacement x. Since the spring is braced on the master cylinder, the driver's proportion in the braking increases, and the boosting decreases. If the booster ensures that the displacement x becomes less, then the driver need not compress the spring as far, and the perceptible force for the driver becomes less. The boosting factor is thus the result of the already mentioned characteristic curve, which links the displacement x to be set with the position of the booster body s. Implicitly, the boosting factor can thus depend on the actuation position, or can vary with it.

The muscle power of the driver to be exerted at a given position s of the booster body 9, or at a given position of the pedal rod 3, can also be adjusted by adjusting the displacement x. Again assuming a linear spring 8, 19, it can be seen that by adjusting the displacement x by means of the brake booster, the foot power on the part of the driver can be adjusted. Advantageously, this is adjusted as a function of the actuation travel.

Regulating the brake booster can also be done on the basis of a characteristic curve, which describes the relationship between the displacement x to be set and the position of the pedal rod 3, but this will not be addressed in further detail here.

Both modes of operation can be used on their own or in combination with one another to operate the brake booster upon a brake actuation. They do not necessarily have to be performed in succession.

To describe a booster characteristic curve and along with a pedal feel, however, the brake booster can be operated in the first mode of operation first, and after that in the second mode of operation. The transition between the first and second modes of operation can be dependent on the pressure prevailing in the brake system, the displacement s of the booster body 9, and/or the displacement of the input element 3, and can thus be established on the basis of those variables.

Changing this kind of booster characteristic curve at the request of a vehicle driver is possible; for instance, the vehicle driver can select among various modes, for instance a normal mode and a sport mode. It is also possible to select the booster characteristic curve on the basis of ambient conditions of the vehicle and/or driving situations.

The selection of a characteristic curve need not pertain to both modes of operation. It is equally possible to vary the characteristic curve only in the second mode of operation and to leave the booster behavior in the first mode of operation, optionally along with the transition point to the second mode of operation, unchanged.

Auxiliary braking if the actuator 2 fails can be done by muscle power, by depressing the brake pedal 5. The muscle power is transmitted to the output element 6 via the piston rod 3 and the transmission element 8. In the auxiliary braking, the actuator 2 need not be moved along as well, and therefore no muscle power for moving it has to be exerted.

1-16. (canceled)

17. A controllable brake booster, having an input element actuatable by muscle power, having an actuator, and having an output element with which a piston of a master cylinder can be subjected to an actuation force, and which output element can be subjected by the input element to muscle power and/or by the actuator to an actuator force, the actuator having a booster body, wherein:
the input element has a deformable transmission element, which transmits the muscle power of the input element to the output element and is not acted upon by the actuator; and
the controllable brake booster is operated as a function of a variable representing a relative displacement of the booster body and of the input element.

18. The controllable brake booster as defined by claim 17, wherein the input element has an idle travel, before it acts on the output element via the transmission element, and in a first mode of operation, by adjustment of the relative displacement, the brake booster is operated such that the idle travel is not overcome, and/or in a second mode of operation, the brake booster is operated, by adjustment of the relative displacement, in such a manner that the idle travel is overcome.

19. The controllable brake booster as defined by claim 18, wherein in the first mode of operation, the brake force is exerted solely by the actuator force, and in the second mode of operation, the brake force is exerted by the actuator force and/or by the muscle power.

20. The controllable brake booster as defined by claim 18, wherein in the first mode of operation, the brake booster is operated such that there is a fixed relative displacement, in particular none, between the input element and the booster body.

21. The controllable brake booster as defined by claim 19, wherein in the first mode of operation, the brake booster is operated such that there is a fixed relative displacement, in particular none, between the input element and the booster body.

22. The controllable brake booster as defined by claim 18, wherein in the second mode of operation, the brake booster is operated such that the relative displacement is adjusted on the basis of a predetermined relationship between the relative displacement and a displacement travel of the booster body.

23. The controllable brake booster as defined by claim 19, wherein in the second mode of operation, the brake booster is operated such that the relative displacement is adjusted on the basis of a predetermined relationship between the relative displacement and a displacement travel of the booster body.

24. The controllable brake booster as defined by claim 20, wherein a transition between the first and second mode of operation is adjusted, in particular as a function of pressure prevailing in the brake system and/or of the displacement travel of the booster body and/or of a displacement travel of the input element.

25. The controllable brake booster as defined by claim 22, wherein a transition between the first and second mode of operation is adjusted, in particular as a function of pressure prevailing in the brake system and/or of the displacement travel of the booster body and/or of a displacement travel of the input element.

26. The controllable brake booster as defined by claim 20, wherein a relationship between an existing displacement travel of the booster body and the relative displacement, to be adjusted, of the booster body and of the input element is stored in memory in as at least one characteristic curve, in particular in a control unit of the brake booster.

27. The controllable brake booster as defined by claim 22, wherein a relationship between an existing displacement travel of the booster body and the relative displacement, to be adjusted, of the booster body and of the input element is stored in memory in as at least one characteristic curve, in particular in a control unit of the brake booster.

28. The controllable brake booster as defined by claim 26, wherein the characteristic curve to be used is selected by a driver of a vehicle having the brake booster and/or is adapted to ambient conditions of the vehicle.

29. The controllable brake booster as defined by claim 22, wherein the muscle power to be exerted at an existing displacement travel is adjusted by adjusting the relative displacement.

30. The controllable brake booster as defined by claim 17, wherein a ratio of the actuator force to the muscle power is adjusted by operating the brake booster by adjusting the relative displacement.

31. The controllable brake booster as defined by claim 30, wherein the ratio of actuator force to muscle power and/or a relationship between the displacement travel and the relative displacement to be adjusted is adjusted as a function of a speed and/or an acceleration of the booster body and/or of the input element.

32. The controllable brake booster as defined by claim 31, wherein signals from sensors are used for determining the displacement travel, the relative displacement, and the speed and/or the acceleration of the booster body and/or of the input element.

33. The controllable brake booster as defined by claim 17, wherein the actuator has a deformable transmission element, which transmits the actuator force from the actuator to the output element.

34. The controllable brake booster as defined by claim 17, wherein the transmission element of the input element and/or of the actuator is elastically deformable and/or has a damping effect.

35. The controllable brake booster as defined by claim 17, wherein input element and/or the actuator has an elastic element and a damper.

36. The controllable brake booster as defined by claim 17, wherein the transmission element of the input element is elastic and has no prestressing.
